(19) United States
(12) Patent Application Publication
(10) Pub. No.: US 2026/0104393 A1
(43) Pub. Date: Apr. 16, 2026

(54) VIRTUAL TIME REVERSAL METHOD FOR AIR-COUPLED LAMB WAVES BASED ON CHIRP SIGNAL TECHNOLOGY

(71) Applicant: Harbin Institute of Technology, Harbin City (CN)

(72) Inventors: Xiang Li, Harbin City (CN); Bingquan Wang, Harbin City (CN); Weijia Shi, Harbin City (CN); Bo Zhao, Harbin City (CN)

(21) Appl. No.: 19/345,251

(22) Filed: Sep. 30, 2025

(30) Foreign Application Priority Data
Oct. 12, 2024 (CN) 202411418982.6

(51) Int. Cl. G01N 29/06; G01N 29/44

(52) U.S. Cl. CPC G01N 29/0654; G01N 29/44; G01N 2291/023

(57) ABSTRACT

Disclosed is a virtual time reversal method for air-coupled Lamb waves based on chirp signal technology in the technical field of communication signals. The method includes the following steps: S1: a computer controls a detection system to apply an excitation signal to a target structure, collects a received signal fed back from the target structure, and calculates a transfer function of the detection system; and S2: the computer generates a narrowband pulse excitation signal based on the transfer function, controls the detection system to apply the narrowband pulse excitation signal to excite the target structure, collects a received narrowband pulse signal fed back from the detection system, and performs virtual time reversal to obtain a reversed focused signal.

### TECHNICAL FIELD

This disclosure relates to a virtual time reversal method based on signal technology in the technical field of communication signals.

### BACKGROUND

The development of non-destructive testing technologies for thin-walled structures (such as pipelines, wind turbine blades, aircraft fuselages, pressure vessels, and ship hulls) has gained significant interest from contemporary researchers due to their application prospects and associated challenges. In recent years, ultrasonic guided wave technology, as an advanced non-destructive testing and structural health monitoring method, has demonstrated broad application potential in the evaluation of plate-like structural components. Particularly, guided wave propagation technology based on Lamb waves has gained prominence due to its ability to propagate over relatively long distances while maintaining sensitivity to minor structural changes, offering advantages in detecting minor damage (with a size of larger than half the wavelength). Furthermore, Lamb wave-based guided wave propagation technology can generate ultrasonic waves easily using low-cost piezoelectric transducers and minimal energy, resulting in relatively low implementation costs. Consequently, it has been widely applied for defect detection in thin-plate structures such as metals and composite materials.

Conventional baseline-based air-coupled Lamb wave testing methods are susceptible to factors such as variations in external environmental and operational conditions, which can introduce relatively large errors in these detection methods that rely on comparisons with baseline data. To address this issue, as well as the challenge in obtaining baseline data, extensive research has been conducted on baseline-free detection methods based on guided waves. The Lamb wave time reversal method, as a baseline-free damage detection method, has been widely studied. Compared to the time reversal method, the virtual time reversal method requires only a single forward physical signal capture configuration, as the backward transmission process is actually replaced by computer signal operations, greatly simplifying the detection steps.

To ensure effective mechanical energy transfer from ultrasonic transducers to specimens, conventional contact ultrasonic testing methods often employ water, glycerol, or Vaseline as a coupling agent. However, the use of coupling agents greatly reduces detection efficiency and may contaminate the tested materials. Air-coupled ultrasonic testing technology utilizes air as a coupling medium, offering non-contact and contamination-free characteristics. Nevertheless, there is currently no virtual time reversal solution specifically designed for air-coupled ultrasonic testing. Additionally, in existing virtual time reversal experiments, since virtual time reversal of broadband signals fails due to amplitude dispersion across different frequency components, most approaches utilize narrowband pulse signals as excitation signals. However, narrowband pulse signals contain certain frequency components with amplitudes approaching or equal to zero, which introduces numerical errors during the calculation of transfer functions, thereby limiting the accuracy of the focused signals obtained through virtual time reversal. For example: assuming that a frequency-domain signal corresponding to a first excitation time-domain signal Vₑ(t) is Vₑ(ω), a frequency-domain signal corresponding to a first received time-domain signal Vᵣ(t) is Vᵣ(Φ), a frequency-domain signal corresponding to a second excitation signal V′ₑ(t) is V′ₑ(Φ), and a frequency-domain signal corresponding to a second received signal V′ᵣ(t) is V′ᵣ(w), since time reversal of a time-domain signal is equivalent to conjugation in the frequency domain, given that the transfer function of the frequency-domain signal is G(r,ω), the following relational expressions can be derived:

$${V}_{e} ( ω ) = F T ( {V}_{e} ( t ) ) ; \qquad ( 13 )$$

$${V}_{r} ( t ) = F T ( {V}_{r} ( ω ) ) ; \qquad ( 14 )$$

$${V}_{r} ( ω ) = {V}_{e} ( ω ) G ( r , ω ) ; \qquad ( 15 )$$

$${V}_{e}^{′} ( ω ) = {V}_{r}^{*} ( ω ) ; \qquad ( 16 )$$

$${V}_{r}^{′} ( ω ) = {V}_{e}^{′} ( ω ) G ( r , ω ) . \qquad ( 17 )$$

Combining the equations (13) to (17) yields:

$${V}_{r}^{′} ( t ) = IFT ( {V}_{r}^{′} ( ω ) ) . \qquad ( 18 )$$

If no defect exists, due to the linear relationship in the virtual time reversal algorithm process, the reconstructed V′ᵣ(Φ) will be completely equal to Vₑ(t) after normalization; if a defect exists, it will destroy the time reversibility, causing the reconstruction to fail and resulting in differences between the reconstructed signal V′ᵣ(Φ) and Vₑ(t). Therefore, the core of the virtual time reversal algorithm lies in the accurate reproduction of the transfer function. The accuracy of the transfer function affects the waveform of the reversed focused signal. Since conventional narrowband pulse signals may contain zero or near-zero points of amplitude within the frequency band during the calculation of the transfer function, this can lead to numerical errors in the transfer function, compromising the waveform accuracy of the reversed focused signal.

Therefore, there is an urgent need to propose a virtual time reversal method for air-coupled Lamb waves based on chirp signal technology to address the aforementioned technical issues.

### SUMMARY

To address the aforementioned issues, a virtual time reversal method for air-coupled Lamb waves based on chirp signal technology is provided. The following presents a brief summary of this disclosure to offer a basic understanding of certain aspects thereof. It should be understood that this summary is not an exhaustive summary of this disclosure. It is not intended to identify key or critical elements of this disclosure, nor to delineate the scope of this disclosure.

The technical solution of this disclosure is as follows:
a virtual time reversal method for air-coupled Lamb waves based on chirp signal technology, which utilizes the chirp signal technology to implement the virtual time reversal method (CRVTR). By leveraging high-bandwidth characteristics of chirp signal excitation, a structural transfer function under chirp signals is obtained. This transfer function is then used to perform virtual time reversal under narrowband signal excitation. The method includes the following steps:
S1: a computer controls a detection system to apply an excitation signal to a target structure, collects a received signal fed back from the target structure via the detection system, and calculates a transfer function of the detection system based on the excitation signal and the received signal; and
S2: the computer generates a narrowband pulse excitation signal based on the transfer function, controls the detection system to apply the narrowband pulse excitation signal to excite the target structure, collects a received narrowband pulse signal fed back from the detection system, and performs virtual time reversal on the received narrowband pulse signal to obtain a reversed focused signal.

Preferably, in the step S1, the detection system includes an air-coupled transducer A and an air-coupled transducer B, and the target structure is a thin-walled structure or thin-plate structure, where the air-coupled transducer A applies an excitation signal to the target structure and the air-coupled transducer B receives the signal; a distance between the air-coupled transducer A and the to-be-tested target structure may be fixed or variable; and a distance between the air-coupled transducer B and the to-be-tested target structure may be fixed or variable.

Preferably, in the step S1, the input chirp signal is Sₑ(t), corresponding to a frequency-domain signal Sₑ(ω), and a received time-domain signal is Sᵣ(t), corresponding to a frequency-domain signal Sᵣ(ω); the transfer function of the detection system is calculated according to the following formula:

$${S}_{r} ( ω ) = {G}_{A} ( ω ) {G}_{B} ( ω ) {S}_{e} ( ω ) {G}_{A B} ( r , ω ) {e}^{- 2 α h} ; \qquad ( 1 )$$

where r represents a propagation distance of the Lamb waves; ω represents an angular frequency; α represents an attenuation coefficient of ultrasonic waves in air; h represents a distance between an air-coupled ultrasonic transducer and a to-be-tested thin plate; G_{A}(Φ) represents a transfer function of the excitation air-coupled transducer A; G_{B}(Φ) represents a transfer function of the receiving air-coupled transducer B; G_{AB}(r,ω) represents a structural transfer function from an excitation point A to an excitation point B in the plate structure; and
by establishing a relationship through a Fourier transform, the transfer function of the detection system is as follows:

$$G ( ω ) = {G}_{A} ( ω ) {G}_{B} ( ω ) {G}_{A B} ( r , ω ) {e}^{- 2 α h} = \frac{{S}_{r} ( ω )}{{S}_{e} ( ω )} ; \qquad ( 2 )$$

where e represents a base of a natural logarithm in an exponential function, used to describe a complex exponential form of a signal in a frequency domain.

Preferably, in the step S2, the transfer function is a broadband transfer function applicable to multiple different frequencies; subsequently, based on the transfer function G(Φ), the virtual time reversal is performed on the narrowband pulse signal; assuming that a frequency-domain signal corresponding to a first excitation time-domain signal Vₑ(t) is Vₑ(Φ), a frequency-domain signal corresponding to a first received time-domain signal V′ᵣ(t) is V′ᵣ(Φ), a frequency-domain signal corresponding to a second excitation signal V′ₑ(t) is V′e(Φ), and a frequency-domain signal corresponding to a second received signal V′ᵣ(t) is V′ᵣ(Φ), among these signals, given that the frequency-domain signal corresponding to the original input signal Vₑ(t) is Vₑ(ω), the following relational expressions can be derived from the aforementioned transfer function:

$${V}_{r} ( ω ) = {V}_{e} ( ω ) G ( ω ) ; \qquad ( 3 )$$

$${V}_{e}^{′} ( ω ) = {V}_{r}^{*} ( ω ) ; \qquad ( 4 )$$

$${V}_{r}^{′} ( ω ) = {V}_{e}^{′} ( ω ) G ( ω ) = {V}_{e}^{*} ( ω ) {G}^{*} ( ω ) G ( ω ) ; \qquad ( 5 )$$

$${V}_{r}^{′} ( t ) = \frac{1}{2 π} {\int }_{- ∞}^{∞} {V}_{r}^{′} ( ω ) {e}^{i ω t} dt ; \qquad ( 6 )$$

to perform time reversal, a complex conjugate operation should be applied to Vᵣ(t) to obtain a reversed signal V′ᵣ(t), where ‘*’ represents the complex conjugate operation; and
in the above expressions, a final obtained time-reversed signal is V′ᵣ(t), and the signal converges to a master mode.

Preferably, in the step S1, the structural transfer function of the detection system is calculated according to the formula (2); the transducer transfer functions are integrated into the structural transfer function, simplifying a derivation process of the transfer function;

$${S}_{r} ( ω ) = {S}_{e} ( ω ) G ( r , ω ) {e}^{- 2 α h} ; \qquad ( 7 )$$

where G(r,ω) is equivalent to G_{AB}(r,ω), representing the transfer function from the excitation point A to the excitation point B in the detection system; and
when distances between the air-coupled transducers A, B and the target structure are fixed, attenuation of the ultrasonic waves in air is constant, imposing no effect on either a virtual time reversal process of the Lamb waves or the transfer function; thus the transfer function of the detection system can be further written as:

$$G ( r , ω ) = \frac{{S}_{r} ( ω )}{{S}_{e} ( ω )} . \qquad ( 8 )$$

Preferably, in the step S2, as shown in FIG. 3, assuming that a Hanning window-modulated five-cycle sinusoidal signal is Vₑ(t), with its corresponding frequency-domain signal being Vₑ(Φ), first, the first received time-domain signal Vᵣ(t) is obtained according to the aforementioned transfer function, with its corresponding frequency-domain signal being Vᵣ(Φ);

$${V}_{r} ( ω ) = {V}_{e} ( ω ) G ( ω ) ; \qquad ( 9 )$$

$${V}_{r} ( t ) = \frac{1}{2 π} {\int }_{- ∞}^{∞} {V}_{r} ( ω ) {e}^{i ω t} dt ; \qquad ( 10 )$$

time reversal is performed on the received signal Vᵣ(t), equivalent to a complex conjugate operation in the frequency domain, yielding the second excitation signal V′ₑ(t), with its corresponding frequency-domain signal being V′ₑ(Φ); the second excitation signal is then transmitted via the air-coupled transducer A along the same path and received by the air-coupled transducer B, obtaining the second received signal V′ᵣ(t), with its corresponding frequency-domain signal being V′ᵣ(t), as shown in the formula (22);

$${V}_{r}^{′} ( ω ) = {V}_{e}^{′} ( ω ) G ( ω ) = {V}_{e}^{*} ( ω ) {G}^{*} ( ω ) G ( ω ) ; \qquad ( 11 )$$

$${V}_{r}^{′} ( t ) = \frac{1}{2 π} {\int }_{- ∞}^{∞} {V}_{r}^{′} ( ω ) {e}^{i ω t} dt ; \qquad ( 12 )$$

when no damage exists along the path, the reversed focused signal V′ᵣ(t) can reconstruct the waveform of the original input signal Vₑ(t). Even if unavoidable amplitude dispersion persists, it can at least reconstruct the shape of the original input signal. When damage exists along the path, it disrupts the time reciprocity of the detection path, preventing the reversed focused signal from completely reconstructing the original input signal. This characteristic can be utilized to perform baseline-free detection of Lamb waves.

Preferably, the virtual time reversal method for the air-coupled Lamb waves based on the chirp signal technology is applied to non-destructive testing of thin-walled structures.

This disclosure has the following beneficial effects:
this disclosure utilizes the broadband transfer function of chirp signals to replace conventional narrowband transfer functions during the calculation of time reversal. This avoids numerical errors in the structural transfer function caused by zero or near-zero points of frequency amplitude in narrowband pulse signals, significantly improving the accuracy of the reversed focused signal;
this disclosure prevents the failure to reconstruct the original input signal when using broadband signals themselves for time reversal; and
the transfer function obtained by this disclosure possesses a certain bandwidth, enabling its simultaneous application to baseline-free measurements of Lamb waves at multiple frequencies without the need for repeated signal acquisition, thereby improving efficiency.

### BRIEF DESCRIPTION OF THE DRAWINGS

FIG. 1 shows a schematic diagram of virtual time reversal of narrowband pulse signals;

FIG. 2 shows a schematic diagram of an experimental principle of obtaining a transfer function using chirp signals;

FIG. 3 shows a schematic diagram of implementing virtual time reversal of narrowband pulse signals using chirp signals, where G(r,ω) represents a structural transfer function from an excitation signal to a received signal;

FIG. 4 shows a structural transfer function restored using a conventional VTR and a corresponding excitation signal spectrum; and

FIG. 5 shows a comparison diagram of reversed focused signals: (5A) conventional virtual time reversal (VTR); (5B) virtual time reversal based on chirp signal technology (CRVTR).

### DETAILED DESCRIPTION OF THE EMBODIMENTS

To make the purpose, technical solution, and advantages of this disclosure clearer and more comprehensible, this disclosure is described through embodiments illustrated in the accompanying drawings. However, it should be understood that these descriptions are merely exemplary and are not intended to limit the scope of this disclosure. Furthermore, in the following description, descriptions of well-known structures and techniques have been omitted to avoid unnecessary confusion of the concepts of this disclosure.

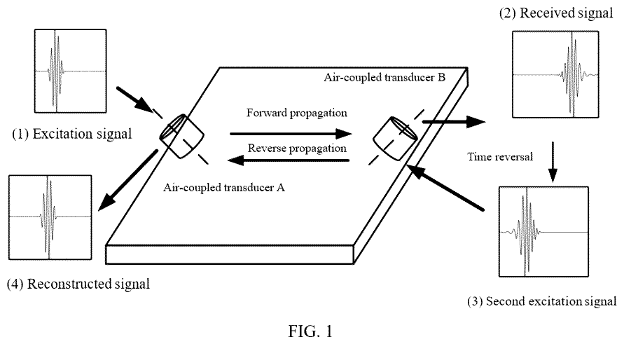

Embodiment I: with reference to FIGS. 1-5, this embodiment describes a virtual time reversal method for air-coupled Lamb waves based on chirp signal technology, which utilizes the chirp signal technology to implement the virtual time reversal method (CRVTR). By leveraging high-bandwidth characteristics of chirp signal excitation, a structural transfer function under chirp signals is obtained. This transfer function is then used to perform virtual time reversal under narrowband signal excitation. Virtual time reversal refers to a pitch-catch mode where an effective signal received by a receiving probe is intercepted, then reversed end-to-end on a time axis to form a new signal that is transmitted from an excitation probe and subsequently received again by the receiving probe. The virtual time reversal method proposed in this disclosure builds upon this concept by using chirp signals to obtain a transfer function that simulates the entire process described above. The method includes the following steps:
S1: a computer controls a detection system to apply an excitation signal to a target structure, collects a received signal fed back from the target structure via the detection system, and calculates a transfer function of the detection system based on the excitation signal and the received signal;
in the step S1, the detection system includes a transducer A and a transducer B, both of which are air-coupled transducers, and the target structure is a thin-walled structure or thin-plate structure, where the air-coupled transducer A applies an excitation signal to the target structure and the air-coupled transducer B receives the signal; a distance between the air-coupled transducer A and the to-be-tested target structure may be fixed or variable; and a distance between the air-coupled transducer B and the to-be-tested target structure may be fixed or variable;
in the step S1, the input chirp signal is Sₑ(t), corresponding to a frequency-domain signal Sₑ(Φ), and a received time-domain signal is Sᵣ(t), corresponding to a frequency-domain signal Sᵣ(ω); the transfer function of the detection system is calculated according to the following formula:

$${S}_{r} ( ω ) = {G}_{A} ( ω ) {G}_{B} ( ω ) {S}_{e} ( ω ) {G}_{A B} ( r , ω ) {e}^{- 2 α h} ; \qquad ( 1 )$$

where r represents a propagation distance of the Lamb waves; w represents an angular frequency; a represents an attenuation coefficient of ultrasonic waves in air; h represents a distance between an air-coupled ultrasonic transducer and a to-be-tested thin plate; G_{A}(Φ) represents a transfer function of the excitation air-coupled transducer A; G_{B}(Φ) represents a transfer function of the receiving air-coupled transducer B; and G_{AB}(r,ω) represents a structural transfer function from an excitation point A to an excitation point B in the plate structure;
by establishing a relationship through a Fourier transform, the transfer function of the detection system is as follows:

$$G ( ω ) = {G}_{A} ( ω ) {G}_{B} ( ω ) {G}_{A B} ( r , ω ) {e}^{- 2 α h} = \frac{{S}_{r} ( ω )}{{S}_{e} ( ω )} ; \qquad ( 2 )$$

where e represents a base of a natural logarithm in an exponential function, used to describe a complex exponential form of a signal in a frequency domain;
S2: the computer generates a narrowband pulse excitation signal based on the transfer function, controls the detection system to apply the narrowband pulse excitation signal to excite the target structure, collects a received narrowband pulse signal fed back from the detection system, and performs virtual time reversal on the received narrowband pulse signal to obtain a reversed focused signal;
in the step S2, the transfer function is a broadband transfer function applicable to multiple different frequencies; subsequently, based on the transfer function G(Φ), the virtual time reversal is performed on the narrowband pulse signal; assuming that a frequency-domain signal corresponding to a first excitation time-domain signal Vₑ(t) is V′ₑ(Φ), a frequency-domain signal corresponding to a first received time-domain signal Vᵣ(t) is Vᵣ(Φ), a frequency-domain signal corresponding to a second excitation signal V′ₑ(t) is V′ₑ(Φ), and a frequency-domain signal corresponding to a second received signal V′ᵣ(t) is V′, (Φ), among these signals, given that the frequency-domain signal corresponding to the original input signal Vₑ(t) is Vₑ(ω), the following relational expressions can be derived from the aforementioned transfer function:

$${V}_{r} ( ω ) = {V}_{e} ( ω ) G ( ω ) ; \qquad ( 3 )$$

$${V}_{e}^{′} ( ω ) = {V}_{r}^{*} ( ω ) ; \qquad ( 4 )$$

$${V}_{r}^{′} ( ω ) = {V}_{e}^{′} ( ω ) G ( ω ) = {V}_{e}^{*} ( ω ) {G}^{*} ( ω ) G ( ω ) ; \qquad ( 5 )$$

$${V}_{r}^{′} ( t ) = \frac{1}{2 π} {\int }_{- ∞}^{∞} {V}_{r}^{′} ( ω ) {e}^{i ω t} dt ; \qquad ( 6 )$$

to perform time reversal, a complex conjugate operation should be applied to Vᵣ(t) to obtain a reversed signal V′ᵣ(t), where ‘*’ represents the complex conjugate operation; i and t are introduced during the inverse Fourier transform process, with i representing an imaginary number and t representing time. These symbols carry no specific meaning beyond indicating that V(ω) corresponds to the time-domain signal V(t);
in the above expressions, a final obtained time-reversed signal is V′ᵣ(t), and the signal converges to a master mode. Therefore, this signal is also referred to as the reversed focused signal. Since the calculation of time reversal utilizes the broadband transfer function of chirp signals instead of conventional narrowband transfer functions, it avoids numerical errors in the structural transfer function caused by zero or near-zero points of frequency amplitude in narrowband pulse signals, thereby ultimately enhancing the accuracy of the reversed focused signal. Simultaneously, it prevents the failure to reconstruct the original input signal when using broadband signals themselves for time reversal. Additionally, due to the high-bandwidth characteristics of chirp signals, the transfer function obtained by this method possesses a certain bandwidth, enabling its simultaneous application to baseline-free measurements of Lamb waves (plate waves) at multiple frequencies without the need for repeated signal acquisition; and
this disclosure utilizes the chirp signal technology to implement the virtual time reversal method (CRVTR). By leveraging high-bandwidth characteristics of chirp signal excitation, a structural transfer function under chirp signals is obtained. This transfer function is then used to perform virtual time reversal under narrowband signal excitation. This method not only avoids errors generated during the calculation of the structural transfer function due to zero or near-zero points of frequency amplitude in narrowband pulse signals, but also leverages the high-bandwidth characteristics of chirp signals, enabling the obtained transfer function to simultaneously achieve virtual time reversal for narrowband pulse signals at multiple different frequencies, thereby effectively improving detection efficiency.

Embodiment II: with reference to FIGS. 1-5, this embodiment describes a virtual time reversal method for air-coupled Lamb waves based on chirp signal technology, including the following steps:
S1: calculating a structural transfer function of a detection system according to the formula (2); integrating a transducer transfer function into the structural transfer function to simplify a derivation process of the transfer function;

$${S}_{r} ( ω ) = {S}_{e} ( ω ) G ( r , ω ) {e}^{- 2 α h} ; \qquad ( 7 )$$

where G(r,ω) is equivalent to G_{AB}(r,ω), representing the transfer function from the excitation point A to the excitation point B in the detection system;
when distances between the air-coupled transducers A, B and the target structure are fixed, attenuation of the ultrasonic waves in air is constant, imposing no effect on either a virtual time reversal process of the Lamb waves or the transfer function; thus the transfer function of the detection system can be further written as:

$$G ( r , ω ) = \frac{{S}_{r} ( ω )}{{S}_{e} ( ω )} ; \qquad ( 8 )$$

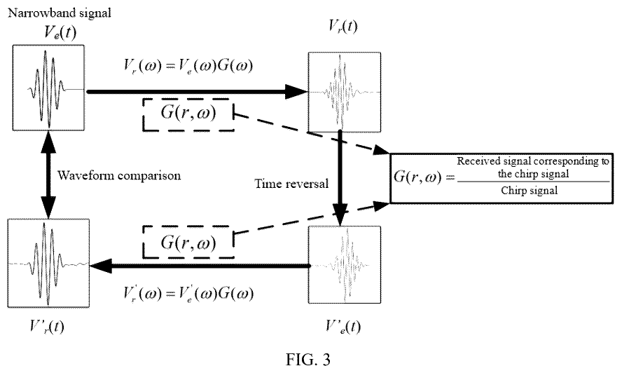

S2: as shown in FIG. 3, assuming that a Hanning window-modulated five-cycle sinusoidal signal is Vₑ(t), with its corresponding frequency-domain signal being Vₑ(Φ), first, obtaining a first received time-domain signal Vᵣ(t) according to the aforementioned transfer function, with its corresponding frequency-domain signal being Vᵣ(Φ);

$${V}_{r} ( ω ) = {V}_{e} ( ω ) G ( ω ) ; \qquad ( 9 )$$

$${V}_{r} ( t ) = \frac{1}{2 π} {\int }_{- ∞}^{∞} {V}_{r} ( ω ) {e}^{i ω t} dt ; \qquad ( 10 )$$

time reversal is performed on the received signal Vᵣ(t), equivalent to a complex conjugate operation in the frequency domain, yielding a second excitation signal V′ₑ(t), with its corresponding frequency-domain signal being V′ₑ(Φ); the second excitation signal is then transmitted via the air-coupled transducer A along the same path and received by the air-coupled transducer B, obtaining the second received signal V′ᵣ(t), with its corresponding frequency-domain signal being V′ᵣ(t);

$${V}_{r}^{′} ( ω ) = {V}_{e}^{′} ( ω ) G ( ω ) = {V}_{e}^{⋆} ( ω ) {G}^{⋆} ( ω ) G ( ω ) ; \qquad ( 11 )$$

$${V}_{r}^{′} ( t ) = \frac{1}{2 π} {\int }_{- ∞}^{∞} {V}_{r}^{′} ( ω ) {e}^{i ω t} dt ; \qquad ( 12 )$$

when no damage exists along the path, the reversed focused signal V′ᵣ(t) can reconstruct the waveform of the original input signal Vₑ(t). Even if unavoidable amplitude dispersion persists, it can at least reconstruct the shape of the original input signal. When damage exists along the path, it disrupts the time reciprocity of the detection path, preventing the reversed focused signal from completely reconstructing the original input signal. This characteristic can be utilized to perform baseline-free detection of Lamb waves.

### Example 1

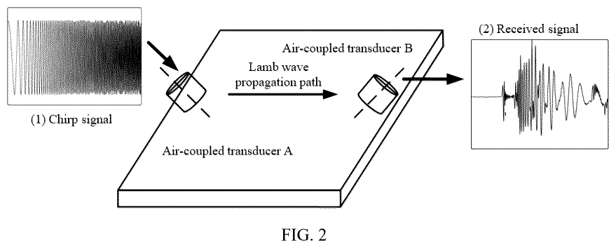

This disclosure proposes using chirp signals to calculate a transfer function G(r,ω) and then applying this transfer function G(r,ω) to a virtual time reversal process of narrowband pulse signals to achieve accurate reproduction of the transfer function G(r,ω);
as shown in FIG. 2, when an excitation voltage Vₑ(t) is applied to an air-coupled transducer A, a frequency-domain signal V′ᵣ(Φ) corresponding to a response signal Vᵣ(t) received by an air-coupled transducer B is as follows:

$${V}_{r} ( ω ) = {G}_{A} ( ω ) {G}_{B} ( ω ) {V}_{e} ( ω ) {G}_{A B} ( r , ω ) {e}^{- 2 α h} ; \qquad ( 19 )$$

where r or r_{AB} represents a propagation distance of the Lamb waves; ω represents an angular frequency; α represents an attenuation coefficient of ultrasonic waves in air; h represents a distance between an air-coupled ultrasonic transducer and a to-be-tested thin plate; G_{A}(ω) represents a transfer function of the excitation air-coupled transducer A; G_{A}(Φ) represents a transfer function of the receiving air-coupled transducer B; G_{AB}(r,Φ) represents a structural transfer function from an excitation point A to an excitation point B in the plate structure; in the thin-plate structure, there are two master guided wave modes for low-frequency signals: A₀ and S₀ modes; and G_{AB}(r,ω) can be further expressed as follows:

$${G}_{A B} ( r , ω ) = A ( r , ω ) {e}^{- ik ( ω ) {r}_{A B}} ; \qquad ( 20 )$$

where A(r,ω) represents an amplitude-frequency response of a received Lamb wave signal; k(ω) represents a wavenumber; r_{AB} represents that the distance here equals a distance from the air-coupled transducer A to the air-coupled transducer B; when the distance h between the air-coupled ultrasonic transducer and the to-be-tested thin plate is fixed, propagation attenuation of the ultrasonic waves in air e^{-ah} becomes a constant, which has no effect on the time reversal process. Thus, the following formula is derived:

$${V}_{r} ( ω ) = {G}_{A} ( ω ) {G}_{B} ( ω ) {V}_{e} ( ω ) A ( r , ω ) ) {e}^{- ik ( ω ) r} ; \qquad ( 21 )$$

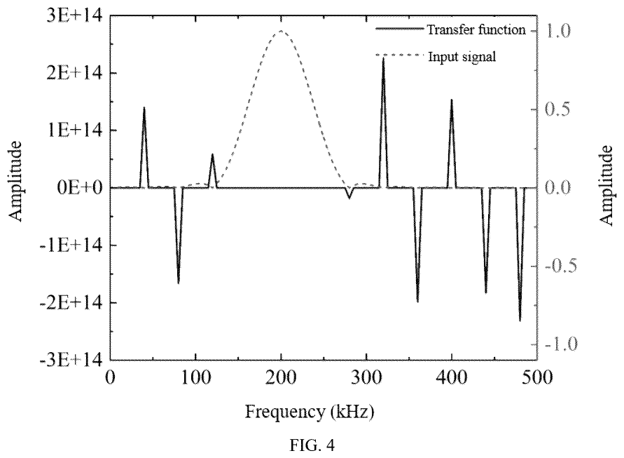

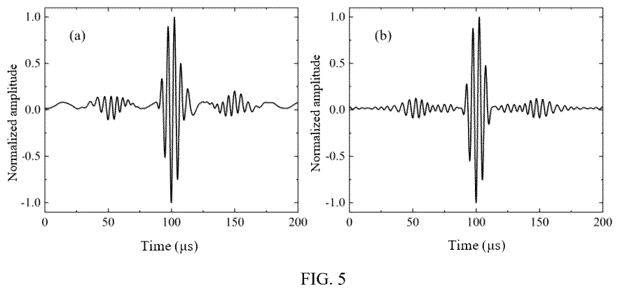

by performing time reversal on the received signal, which corresponds to conjugation in the frequency domain, the reversed signal can be expressed as follows:

$${V}_{e}^{′} ( ω ) = {V}_{r}^{*} ( ω ) = {G}_{A}^{*} ( ω ) {G}_{B}^{*} ( ω ) {V}_{e}^{*} ( ω ) {G}_{A B}^{*} ( {r}_{A B} , ω ) ; \qquad ( 22 )$$

where ‘*’ represents a complex conjugate operation, and G_{AB} represents a structural transfer function for Lamb wave propagation over the distance r_{AB} in the plate structure;
using the obtained V′A(ω) from the equation as an excitation signal applied to the air-coupled transducer B, with the air-coupled transducer A now acting as the receiving transducer, the received Lamb wave signal is as follows:

$$\begin{matrix}{V}_{r}^{′} ( ω ) = {\vert {G}_{A} ( ω ) {G}_{B} ( ω ) \vert}^{2} {V}_{e}^{*} ( ω ) {\vert A ( {r}_{A B} , ω ) \vert}^{2} {e}^{- ik ( ω ) {r}_{AB} - {r}_{AB} )} \\ = {\vert {G}_{A} ( ω ) {G}_{B} ( ω ) \vert}^{2} {\vert A ( {r}_{A B} , ω ) \vert}^{2} {V}_{e}^{*} ( ω )\end{matrix} ; \qquad ( 23 )$$

where A(r_{AB}, w) represents the amplitude-frequency response of the Lamb waves at the receiving point after propagating the distance r_{AB};
assuming that K=G_{A}(Φ)G_{B}(Φ) represent the transfer function of the air-coupled ultrasonic transducer in the system, and Γ=|A(r,ω)|² represent the time reversal operator, then the structural transfer function from the excitation end A to the receiving end B is G(r,ω)=K·Γ, where the transducer transfer function K is determined by the inherent characteristics of the transducer and is independent of the excitation signal, while Γ is generated by the propagation of Lamb waves in the plate structure; and
since e^{-ik(Φ)r} is eliminated during the calculation of time reversal, as shown in the formula (20), both intramodal dispersion and multimodal dispersion are compensated. However, the presence of A(r,ω) indicates that amplitude dispersion still exists in the reconstructed signal. Different frequency components are unevenly amplified during the time reversal process, preventing perfect reconstruction of the original broadband signal when using broadband signals for virtual time reversal. The uneven scaling and superposition of different frequency components ultimately lead to reconstruction failure. Therefore, broadband signals cannot be directly used for time reversal. Instead, the transfer function calculated from broadband signals is applied to narrowband pulse signals. This approach not only addresses the inaccuracy of transfer function reproduction with narrowband pulse signals (as shown in FIG. 4) but also avoids the failure to reconstruct the original input signal when using broadband signals themselves for time reversal. A comparison of reversed focused signals achieved using the conventional VTR method and the CRVTR method proposed in this disclosure is shown in FIG. 5. Additionally, due to the high-bandwidth characteristics of chirp signals, the transfer function obtained using the CRVTR method possesses a certain bandwidth, enabling its simultaneous application to baseline-free measurements of Lamb waves at multiple frequencies without the need for repeated signal acquisition, thereby effectively improving detection efficiency.

It should be noted that in the above example, all technical solutions that are not contradictory can be combined and permuted. Those skilled in the art can exhaust all possibilities based on mathematical knowledge of combinations and permutations. Therefore, this disclosure will not elaborate on each combined and permuted technical solution one by one, but it should be understood that all combined and permuted technical solutions are already disclosed herein.

The foregoing is only illustrative of the exemplary embodiments of this disclosure and is not intended to limit this disclosure. Various changes and modifications may be made by those skilled in the art. Any modifications, equivalent replacements, and improvements made within the spirit and principle of this disclosure shall fall within the protection scope of this disclosure.

What is claimed is:

1. A virtual time reversal method for air-coupled Lamb waves based on chirp signal technology, comprising the following steps:
S1: a computer controls a detection system to apply an excitation signal to a target structure, collects a received signal fed back from the target structure via the detection system, and calculates a transfer function of the detection system based on the excitation signal and the received signal; and
S2: the computer generates a narrowband pulse excitation signal based on the transfer function, controls the detection system to apply the narrowband pulse excitation signal to excite the target structure, collects a received narrowband pulse signal fed back from the detection system, and performs virtual time reversal on the received narrowband pulse signal to obtain a reversed focused signal.

2. The virtual time reversal method for the air-coupled Lamb waves based on the chirp signal technology of claim 1, wherein in the step S1, the detection system comprises a transducer A and a transducer B, wherein the transducer A applies an excitation signal to the target structure and the transducer B collects a received signal fed back from the target structure.

3. The virtual time reversal method for the air-coupled Lamb waves based on the chirp signal technology of claim 2, wherein in the step S1, the applied excitation signal is a chirp signal represented by Sₑ(t), corresponding to a frequency-domain signal Sₑ(Φ), and the received signal is Sᵣ(t), corresponding to a frequency-domain signal Sᵣ(ω);
$${S}_{r} ( ω ) = {G}_{A} ( ω ) {G}_{B} ( ω ) {S}_{e} ( ω ) {G}_{A B} ( r , ω ) {e}^{- 2 α h} ; \qquad ( 1 )$$
wherein r represents a propagation distance of the Lamb waves; ω represents an angular frequency; α represents an attenuation coefficient of ultrasonic waves in air; h represents a distance between an air-coupled ultrasonic transducer and a to-be-tested thin plate; G_{A}(Φ) represents a transfer function of the excitation transducer A; G_{B}(Φ) represents a transfer function of the receiving transducer B; G_{AB}(r,ω) represents a structural transfer function from an excitation point A to an excitation point B in the plate structure; and
the transfer function of the detection system is as follows:
$$G ( ω ) = {G}_{A} ( ω ) {G}_{B} ( ω ) {G}_{A B} ( r , ω ) {e}^{- 2 α h} = \frac{{S}_{r} ( ω )}{{S}_{e} ( ω )} . \qquad ( 2 )$$

4. The virtual time reversal method for the air-coupled Lamb waves based on the chirp signal technology of claim 3, wherein in the step S2, based on the transfer function G(Φ), the virtual time reversal is performed on the narrowband pulse signal; assuming that a frequency-domain signal corresponding to a first excitation time-domain signal Vₑ(t) is Vₑ(Φ), a frequency-domain signal corresponding to a first received time-domain signal Vᵣ(t) is Vᵣ(Φ), a frequency-domain signal corresponding to a second excitation time-domain signal V′ₑ(t) is V′ₑ(w), and a frequency-domain signal corresponding to a second received time-domain signal V′ᵣ(t) is V′ᵣ(Φ), the following relational expressions are derived:
$${V}_{r} ( ω ) = {V}_{e} ( ω ) G ( ω ) ; \qquad ( 3 )$$
$${V}_{e}^{′} ( ω ) = {V}_{r}^{′} ( ω ) ; \qquad ( 4 )$$
$${V}_{r}^{′} ( ω ) = {V}_{e}^{′} ( ω ) G ( ω ) = {V}_{e}^{⋆} ( ω ) {G}^{⋆} ( ω ) G ( ω ) ; \qquad ( 5 )$$
$${V}_{r}^{′} ( t ) = \frac{1}{2 π} {\int }_{- ∞}^{∞} {V}_{r}^{′} ( ω ) {e}^{i ω t} dt ; \qquad ( 6 )$$
wherein ‘*’ represents a complex conjugate operation; and
an obtained time-reversed signal is V′ᵣ(t), and the signal converges to a master mode.

5. The virtual time reversal method for the air-coupled Lamb waves based on the chirp signal technology of claim 4, wherein in the step S1, the structural transfer function of the detection system is calculated according to the formula (2), simplifying a derivation process of the transfer function;
$${S}_{r} ( ω ) = {S}_{e} ( ω ) G ( r , ω ) {e}^{- 2 α h} ; \qquad ( 7 )$$
when distances between the transducers A, B and the target structure are fixed, attenuation of the ultrasonic waves in air is constant, imposing no effect on either a virtual time reversal process of the Lamb waves or the transfer function; thus the transfer function of the detection system is further written as:
$$G ( r , ω ) = \frac{{S}_{r} ( ω )}{{S}_{e} ( ω )} . \qquad ( 8 )$$

6. The virtual time reversal method for the air-coupled Lamb waves based on the chirp signal technology of claim 5, wherein in the step S2, the first received time-domain signal Vᵣ(t) is obtained according to the transfer function, and its corresponding frequency-domain signal is Vᵣ(Φ);
$${V}_{r} ( t ) = \frac{1}{2 π} {\int }_{- ∞}^{∞} {V}_{r} ( ω ) {e}^{i ω t} dt . \qquad ( 10 )$$

7. The virtual time reversal method for the air-coupled Lamb waves based on the chirp signal technology of claim 6, wherein the method is applied to non-destructive testing of thin-walled structures.
